(19) United States
(12) Patent Application Publication
(10) Pub. No.: US 2018/0290198 A1
(43) Pub. Date: Oct. 11, 2018

(54) OPERATION CONTROL DEVICE AND OPERATION CONTROL METHOD FOR PRESS LINE

(71) Applicant: AIDA ENGINEERING, LTD., Kanagawa (JP)

(72) Inventor: Satoshi SUZUKI, Kanagawa (JP)

(73) Assignee: AIDA ENGINEERING, LTD., Kanagawa (JP)

(21) Appl. No.: 15/761,941

(22) PCT Filed: Sep. 23, 2016
(86) PCT No.: PCT/JP2016/077960

§ 371 Date: Mar. 21, 2018

(30) Foreign Application Priority Data
Sep. 28, 2015 (JP) 2015-189193

(51) Int. Cl. B21D 43/05; B30B 13/00; B30B 15/30; B30B 15/32

(52) U.S. Cl. CPC B21D 43/05; B30B 15/32; B30B 15/30; B30B 13/00

(57) ABSTRACT

An operation control device for a press line in which a first conveyance controller transmits, to a first press controller, time at which a first conveying device exits an interference region in which the first conveying device interferes with a first press machine; the first press controller controls the first press machine so that, at or after a time at which the first conveying device exits the interference region, a slide of the first press machine enters the interference region in which the first press machine interferes with the first conveying device, and transmits, to a second conveyance controller, time at which the slide of the first press machine exits an interference region in which the first press machine interferes with a second conveying device; and the second conveyance controller controls the second conveying device so that, at or after a time at which the slide of the first press machine exits the interference region, the second conveying device enters an interference region in which the second conveying device interferes with the first press machine.

### TECHNICAL FIELD

The present invention relates to an operation control device and an operation control method for a press line.

### BACKGROUND ART

As an operation control method for a press line in which press devices and conveying devices are alternately arranged in a conveying direction of a workpiece, a method of controlling the press line in an integrated manner by generating a command signal by a host controller and transmitting the command signal to controllers of the devices is known (for example, see Japanese Patent Application Publication No. 2008-246529).

### SUMMARY OF INVENTION

### Technical Problem

In the conventional operation control method in which the devices operate in synchronization with a signal (master signal) generated by the host controller, operation command values for servomotors of the devices are affected by communication jitter and difference of CPU clocks among the controllers. Thus, processing for reducing the effects of the communication jitter or the difference of the CPU clocks is needed.

The invention has been made in view of the problem as above, and an object thereof is to provide an operation control device and an operation control method for a press line that enable devices to operate without interfering with each other without relying on a master signal.

### Solution to Problem

(1) According to one embodiment of the invention, there is provided an operation control device for a press line including a first press machine, a first conveying device that carries a workpiece to be processed into the first press machine, and a second conveying device that carries a processed workpiece out of the first press machine, the operation control device including:

a first press controller that controls the first press machine;

a first conveyance controller that controls the first conveying device; and

a second conveyance controller that controls the second conveying device, in which:

the first press controller, the first conveyance controller, and the second conveyance controller are communicably connected to each other;

the first conveyance controller transmits, to the first press controller, time information indicating a timing at which the first conveying device exits an interference region in which the first conveying device interferes with the first press machine (the period necessary for the first conveying device to exit the interference region or the time of day at which the first conveying device exits the interference region);

the first press controller controls the first press machine so that, at or after a time (time of day) at which the first conveying device exits the interference region, a slide of the first press machine enters the interference region in which the first press machine interferes with the first conveying device on the basis of the time information received from the first conveyance controller, and transmit, to the second conveyance controller, time information indicating a timing at which the slide of the first press machine exits an interference region in which the first press machine interferes with the second conveying device; and

the second conveyance controller controls the second conveying device so that, at or after a time at which the slide of the first press machine exits the interference region, the second conveying device enters an interference region in which the second conveying device interferes with the first press machine on the basis of the time information received from the first press controller.

According to one embodiment of the invention, there is provided an operation control method for a press line including a first press machine, a first conveying device that carries a workpiece to be processed into the first press machine, a second conveying device that carries a processed workpiece out of the first press machine, a first press controller that controls the first press machine, a first conveyance controller that controls the first conveying device, and a second conveyance controller that controls the second conveying device, the operation control method including the steps of:

causing the first conveyance controller to transmit, to the first press controller, time information indicating a timing at which the first conveying device exits an interference region in which the first conveying device interferes with the first press machine;

causing the first press controller to control the first press machine so that, at or after a time at which the first conveying device exits the interference region, a slide of the first press machine enters the interference region in which the first press machine interferes with the first conveying device on the basis of the time information received from the first conveyance controller, and transmit, to the second conveyance controller, time information indicating a timing at which the slide of the first press machine exits an interference region in which the first press machine interferes with the second conveying device; and

causing the second conveyance controller to control the second conveying device so that, at or after a time at which the slide of the first press machine exits the interference region, the second conveying device enters the interference region in which the second conveying device interferes with the first press machine on the basis of the time information received from the first press controller.

According to the invention, the first press controller acquires the time information indicating the timing at which the first conveying device exits the interference region from the first conveyance controller, and controls the slide to enter the interference region at or after the time at which the first conveying device exits the interference region, and the second conveyance controller acquires the time information indicating the timing at which the slide exits the interference region from the first press controller, and controls the second conveying device to enter the interference region at or after the time at which the slide exits the interference region. As a result, the devices (the first conveying device and the first press machine, and the first press machine and the second conveying device) can be operated without interfering with each other without relying on a master signal, and operation command values for the devices can be prevented from being affected by communication jitter or the difference of CPU clocks.

(2) In the operation control device and the operation control method for a press line,

the second conveyance controller may transmit, to the first conveyance controller, time information indicating a timing at which the second conveying device exits an interference region in which the second conveying device interferes with the first conveying device; and

the first conveyance controller may control the first conveying device so that, at or after a time at which the second conveying device exits the interference region, the first conveying device enters an interference region in which the first conveying device interferes with the second conveying device on the basis of the time information received from the second conveyance controller.

According to the above embodiments, the first conveyance controller acquires the time information indicating the timing at which the second conveying device exits the interference region from the second conveyance controller, and controls the first conveying device to enter the interference region at or after the time at which the second conveying device exits the interference region. As a result, the devices (the second conveying device and the first conveying device) can be operated without interfering with each other without relying on a master signal.

(3) In the operation control device and the operation control method for a press line,

the first press controller may control the first press machine so that the slide of the first press machine enters the interference region in which the first press machine interferes with the first conveying device, at a speed designated in advance;

the second conveyance controller may control the second conveying device so that the second conveying device enters the interference region in which the second conveying device interferes with the first press machine, at a speed designated in advance; and

the first conveyance controller may control the first conveying device so that the first conveying device enters the interference region in which the first conveying device interferes with the second conveying device, at a speed designated in advance.

According to the above embodiments, the timing at which the slide exits the interference region can be easily calculated by controlling the slide of the first press machine to enter the interference region at a speed designated in advance, the timing at which the second conveying device exits the interference region can be easily calculated by controlling the second conveying device to enter the interference region at a speed designated in advance, and the timing at which the first conveying device exits the interference region can be easily calculated by controlling the first conveying device to enter the interference region at a speed designated in advance.

(4) In the operation control device for a press line,

the press line may further include a second press machine, and a second press controller that controls the second press machine;

the second conveying device may carry a workpiece carried out from the first press machine into the second press machine; and

the second conveyance controller and the second press controller may be communicably connected to each other.

(5) In the operation control device for a press line,

the second conveyance controller may transmit, to the second press controller, time information indicating a timing at which the second conveying device exits an interference region in which the second conveying device interferes with the second press machine; and

the second press controller may control the second press machine so that, at or after a time at which the second conveying device exits the interference region, a slide of the second press machine enters an interference region in which the second press machine interferes with the second conveying device on the basis of the time information received from the second conveyance controller.

In the operation control method for a press line,

the press line may further include a second press machine, and a second press controller that controls the second press machine;

the second conveying device may carry a workpiece carried out from the first press machine into the second press machine; and

the operation control method may include the steps of:

causing the second conveyance controller to transmit, to the second press controller, time information indicating a timing at which the second conveying device exits an interference region in which the second conveying device interferes with the second press machine; and

causing the second press controller to control the second press machine so that, at or after a time at which the second conveying device exits the interference region, a slide of the second press machine enters an interference region in which the second press machine interferes with the second conveying device on the basis of the time information received from the second conveyance controller.

According to the above embodiments, the second press controller acquires the time information indicating the timing at which the second conveying device exits the interference region from the second conveyance controller, and controls the slide of the second press machine to enter the interference region at or after the time at which the second conveying device exits the interference region. As a result, the devices (the second conveying device and the second press machine) can be operated without interfering with each other without relying on a master signal, and operation command values for the devices can be prevented from being affected by communication jitter or the difference of CPU clocks.

(6) In the operation control device and the operation control method for a press line,

the second press controller may control the second press machine so that the slide of the second press machine enters the interference region in which the second press machine interferes with the second conveying device, at a speed designated in advance.

According to the above embodiments, the timing at which the slide of the second press machine exits the interference region can be easily calculated by controlling the slide of the second press machine to enter the interference region at a speed designated in advance.

(7) In the operation control device and the operation control method for a press line,

the first conveyance controller may update section information indicating an operation section in which the first conveying device is located among a plurality of operation sections obtained by dividing an operation of the first conveying device, and transmit the updated section information to the first press controller;

the second conveyance controller may update section information indicating an operation section in which the second conveying device is located among a plurality of operation sections obtained by dividing an operation of the second conveying device, and transmit the updated section information to the first press controller;

the first press controller may update section information indicating an operation section in which the slide of the first press machine is located among a plurality of operation sections obtained by dividing an operation of the slide of the first press machine, update state information indicating a state of the interference region on the basis of the updated section information, and the section information received from the first conveyance controller and the second conveyance controller, and transmit the updated state information to the first conveyance controller and the second conveyance controller;

the first press controller may control the first press machine so that the slide of the first press machine enters the interference region in which the first press machine interferes with the first conveying device, with minimum time (in accordance with a preset press motion) when the state information indicates that there is a workpiece to be processed, and control the first press machine so that, at or after a time at which the first conveying device exits the interference region, the slide of the first press machine enters the interference region in which the first press machine interferes with the first conveying device on the basis of the time information received from the first conveyance controller in a case other than a case in which the state information indicates that there is a workpiece to be processed;

the second conveyance controller may control the second conveying device so that the second conveying device enters the interference region in which the second conveying device interferes with the first press machine, with minimum time (in accordance with a preset conveyance motion) when the state information received from the first press controller indicates that there is a processed workpiece, and control the second conveying device so that, at or after a time at which the slide of the first press machine exits the interference region, the second conveying device enters the interference region in which the second conveying device interferes with the first press machine on the basis of the time information received from the first press controller in a case other than a case in which the state information indicates that there is a processed workpiece; and

the first conveyance controller may control the first conveying device so that the first conveying device enters the interference region in which the first conveying device interferes with the second conveying device, with minimum time (in accordance with a preset conveyance motion) when the state information received from the first press controller indicates that there is no workpiece, and control the first conveying device so that, at or after a time at which the second conveying device exits the interference region, the first conveying device enters an interference region in which the first conveying device interferes with the second conveying device on the basis of the time information received from the second conveyance controller in a case other than a case in which the state information indicates that there is no workpiece.

According to the above embodiments, the first press controller acquires the section information indicating the operation sections in which the conveying devices are located from the conveyance controllers, updates the state information indicating the interference state on the basis of the acquired section information and the section information of the first press machine, and transmits the updated state information to the conveyance controllers, and the first press controller and the conveyance controllers determine whether interference is predicted to occur on the basis of the state information, and perform control on the basis of the received time information when interference is predicted to occur. As a result, the controllers can grasp the interference state and securely operate the devices so as not to interfere with each other.

(8) In the operation control device and the operation control method for a press line,

the first press controller may monitor an abnormality of the first press machine, and monitor an abnormality of the first conveying device by monitoring the time information received from the first conveyance controller;

the second conveyance controller may monitor an abnormality of the second conveying device, and monitor an abnormality of the first press machine by monitoring the time information received from the first press controller; and

the first conveyance controller may monitor an abnormality of the first conveying device, and monitor an abnormality of the second conveying device by monitoring the time information received from the second conveyance controller.

According to the above embodiments, the first press controller monitors the abnormality of not only the first press machine but also the first conveying device; the second conveyance controller monitors the abnormality of not only the second conveying device but also the first press machine; and the first conveyance controller monitors the abnormality of not only the first conveying device but also the second conveying device. As a result, the abnormality can be rapidly detected and the operation can be stopped.

### BRIEF DESCRIPTION OF DRAWINGS

FIG. 1 is a diagram for illustrating the configuration of a press line including an operation control device according to one embodiment of the invention.

FIG. 2 is a diagram for illustrating an interference region.

FIG. 3 is a diagram for illustrating an operation locus of a conveying device.

FIG. 4 is a diagram for illustrating an operation locus of a press machine.

FIG. 5 is a functional block diagram for illustrating the configuration of a conveyance controller.

FIG. 6 is a functional block diagram for illustrating the configuration of a press controller.

FIG. 7 is a flowchart illustrating the flow of ganged operation processing of the conveying device.

FIG. 8 is a flowchart illustrating the flow of the ganged operation processing of the conveying device.

FIG. 9 is a flowchart illustrating the flow of ganged operation finishing processing of the conveying device.

FIG. 10 is a flowchart illustrating the flow of processing for outputting an interference region exit period of the conveying device.

FIG. 11 is a flowchart illustrating the flow of ganged operation processing of the press machine.

FIG. 12 is a flowchart illustrating the flow of ganged operation finishing processing of the press machine.

FIG. 13 is a flowchart illustrating the flow of processing for outputting an interference region exit period of the press machine.

FIG. 14 is a diagram illustrating an example of transition of variables generated by an upstream conveyance controller, the press controller, and a downstream conveyance controller.

### DESCRIPTION OF EMBODIMENTS

Some embodiments of the invention are described in detail below with reference to the drawings.

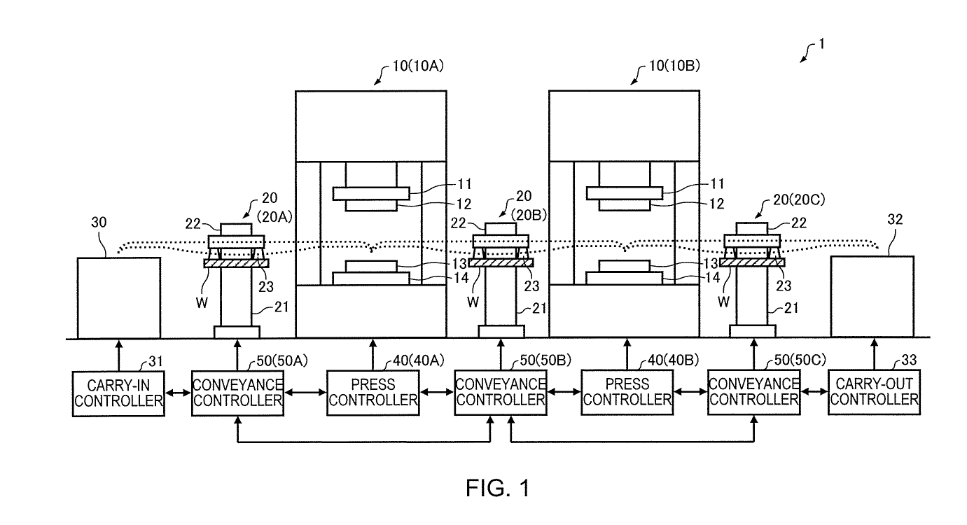

FIG. 1 is a diagram for illustrating the configuration of a press line including an operation control device according to one embodiment of the invention. In a press line 1, press machines 10 and conveying devices 20 are alternately arranged in a workpiece conveying direction (right direction in FIG. 1), and the press line 1 is formed so that a workpiece W is conveyed from an upstream press machine to a downstream press machine with use of the conveying devices 20 and is pressed in each of the press machines 10. Two press machines 10A and 10B and three conveying devices 20A, 20B, and 20C are arranged side by side in the conveying direction. The conveying device 20A functions as an upstream conveying device with respect to the press machine 10A. The conveying device 20B functions as a downstream conveying device with respect to the press machine 10A, and functions as an upstream conveying device with respect to the press machine 10B. The conveying device 20C functions as a downstream conveying device with respect to the press machine 10B. The press machine 10A functions as an upstream press machine with respect to the conveying device 20B, and the press machine 10B functions as a downstream press machine with respect to the conveying device 20B. When the conveying device 20A is considered as a first conveying device, the press machine 10A corresponds to a first press machine, the conveying device 20B corresponds to a second conveying device, and the press machine 10B corresponds to a second press machine. A material carry-in device 30 is disposed on the upstream side of the conveying device 20A, and a material carry-out device 32 is disposed on the downstream side of the conveying device 20C.

The press machine 10 includes a slide 11 that can be moved up and down, an upper die 12 attached to a lower surface of the slide 11, a lower die 13 that performs press working in combination with the upper die 12, and a bolster 14 having an upper surface on which the lower die 13 is mounted and fixed. A driving mechanism that drives the slide 11 of the press machine 10 is well known, and hence is omitted in FIG. 1. Any drive device can be used as long as the drive device drives the slide 11. In this example, the driving mechanism is accommodated in an upper portion of the press machine 10.

The conveying device 20 includes a main body 21, a conveyance body 22, a holding device 23 that holds a workpiece, and a drive device (not shown) that drives the conveyance body 22. FIG. 1 illustrates a vacuum suction device as the holding device 23. However, the holding device 23 is not limited to a suction device, and any type of holding device may be used as long as the holding device has a function that can hold a workpiece. The conveyance body 22 of the conveying device 20 is a device that conveys (feeds) a workpiece held by the holding device 23 in the conveying direction, and also convey (lift) the workpiece in the vertical direction. Well-known examples of the conveyance body 22 include a device including a conveyance arm or a lever mechanism and a device that drives a carrier by a belt or a linear motor. In the description below, the expression “to control the conveying device 20” mainly means “to control the conveyance body 22 of the conveying device 20”, and more specifically means “to transmit a control signal to the drive device (not shown) that drives the conveyance body 22 and control the conveyance body 22 to be driven by the drive device”.

The workpiece W is carried out of the material carry-in device 30 by the conveying device 20A (specifically, the conveyance body 22 and the holding device 23 of the conveying device 20A). Then, the workpiece W is carried into the press machine 10A, pressed, and carried out of the press machine 10A by the conveying device 20B (specifically, the conveyance body 22 and the holding device 23 of the conveying device 20B). Then, the workpiece W is carried into the press machine 10B, pressed, and carried out of the press machine 10B by the conveying device 20C (specifically, the conveyance body 22 and the holding device 23 of the conveying device 20C). Then, the workpiece W is carried out of the material carry-out device 32. The dotted lines in FIG. 1 indicate the motion (workpiece conveyance locus) of the conveying device 20.

The press machine 10A (the operation of the slide 11) is controlled by a press controller 40A, the press machine 10B is controlled by a press controller 40B, the conveying device 20A is controlled by a conveyance controller 50A, the conveying device 20B is controlled by a conveyance controller 50B, and the conveying device 20C is controlled by a conveyance controller 50C. When the conveying device 20A is considered as a first conveying device, the conveyance controller 50A corresponds to a first conveyance controller, the press controller 40A corresponds to a first press controller, the conveyance controller 50B corresponds to a second conveyance controller, and the press controller 40B corresponds to a second press controller. The material carry-in device 30 is controlled by a carry-in controller 31, and the material carry-out device 32 is controlled by a carry-out controller 33. The conveyance controller 50A, the press controller 40A, and the conveyance controller 50B are communicably connected to each other, and the conveyance controller 50B, the press controller 40B, and the conveyance controller 50C are communicably connected to each other. The carry-in controller 31 and the conveyance controller 50A are communicably connected to each other, and the conveyance controller 50C and the carry-out controller 33 are communicably connected to each other.

Three forms in which interference between the press machine 10 and the conveying device 20 may occur are described. The upstream conveying device (the conveying device 20A with respect to the press machine 10A, the conveying device 20B with respect to the press machine 10B) mounts a workpiece W on the lower die 13 (carries the workpiece W into the press machine 10), and then retreats from a press working area to the upstream side. At this time, the slide 11 is moving downward toward the press working area. The downstream conveying device (the conveying device 20B with respect to the press machine 10A, the conveying device 20C with respect to the press machine 10B) has not entered the press working area. Thus, in this form (first form), only the interference between the retreating upstream conveying device and the slide 11 (press machine 10) moving downward needs to be considered.

When the slide 11 starts moving upward from the bottom dead center after the process on the workpiece W is finished, the downstream conveying device enters a workpiece working area in order to carry out the processed workpiece W. The upstream conveying device has not entered the press working area. Thus, in this form (second form), only the interference between the slide 11 moving upward and the intruding downstream conveying device needs to be considered.

The downstream conveying device carries out the processed workpiece W, and retreats from the press working area to the downstream side. At this time, the upstream conveying device enters the workpiece working area in order to carry in a workpiece W to be processed. The slide 11 is located at a height that does not interfere with the conveying devices. Thus, in this form (third form), only the interference between the retreating downstream conveying device and the intruding upstream conveying device needs to be considered.

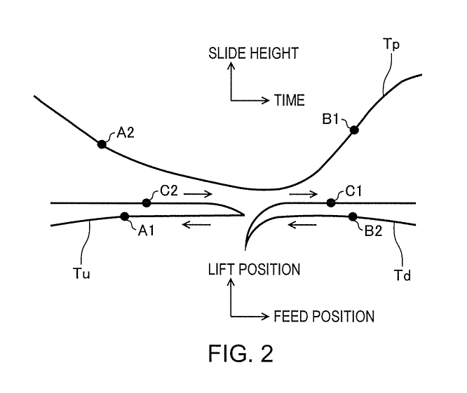

FIG. 2 is a diagram for illustrating an interference region. FIG. 2 illustrates an operation locus Tp of the press machine 10 (slide 11), an operation locus Tu of the upstream conveying device, and an operation locus Td of the downstream conveying device. The operation locus Tp is a locus in which the horizontal axis indicates time and the vertical axis indicates the slide height, and the operation loci Tu and Td are loci in which the horizontal axis indicates the feed position (the position in the horizontal direction) and the vertical axis indicates the lift position (the position in the vertical direction).

In the operation control device (the press controllers 40 and the conveyance controllers 50) according to one embodiment of the invention, parameters about the position (slide height) of the slide 11 and the position (feed position) of the conveying device 20 are set for each of an interference region A (a region of interference between the upstream conveying device and the press machine 10) in the first form, an interference region B (a region of interference between the press machine 10 and the downstream conveying device) in the second form, and an interference region C (a region of interference between the downstream conveying device and the upstream conveying device) in the third form, and whether the press machine 10 and the conveying device 20 are in the interference region is determined on the basis of those parameters.

Specifically, the operation control device sets a position A1 for determining that the upstream conveying device has exited the interference region A, a position A2 for determining that the slide 11 has entered the interference region A, a position B1 for determining that the slide 11 has exited the interference region B, a position B2 for determining that the downstream conveying device has entered the interference region B, a position C1 for determining the downstream conveying device has exited the interference region C, and a position C2 for determining that the upstream conveying device has entered the interference region C.

The conveyance controller 50 on the upstream side transmits the period necessary for the upstream conveying device to pass the position A1 (time information indicating the timing at which the upstream conveying device exits the interference region A) to the press controller 40, the press controller 40 transmits the period necessary for the slide 11 to pass the position B1 (time information indicating the timing at which the slide 11 exits the interference region B) to the conveyance controller 50 on the downstream side, and the conveyance controller 50 on the downstream side transmits the period necessary for the downstream conveying device to pass the position C1 (time information indicating the timing at which the downstream conveying device exits the interference region C) to the conveyance controller 50 on the upstream side. A case in which the period necessary for a device to exit the interference region is transmitted as the time information is described, but the time of day at which the device exits the interference region may be transmitted as the time information. In the latter case, the time of day obtained by adding the period necessary for the device to exit the interference region to the current time of day may be transmitted as the time information. When the time of day is calculated as the time information, the time of day needs to be synchronized among the controllers (the press controllers 40 and the conveyance controllers 50).

In the operation control device according to the embodiments of the invention, “phases” for determining operation sections of the press machine 10 and the conveying device 20 are managed.

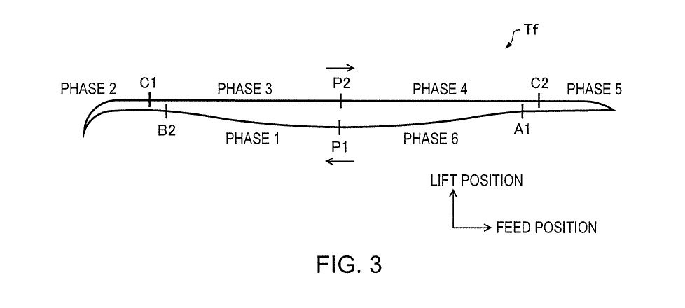

FIG. 3 illustrates an operation locus Tf of the conveying device 20. In the operation locus Tf, a position P1 is set near a middle point obtained when the conveying device 20 moves to the upstream side, and a position P2 is set near a middle point obtained when the conveying device 20 moves to the downstream side. The conveyance controller 50 manages the phases of the conveying device 20 by setting a phase in which the conveying device 20 is located in a section from the position P1 to the position B2 as a phase 1, a phase in which the conveying device 20 is located in a section from the position B2 to the position C1 (a section from when the conveying device 20 enters the interference region B to when the conveying device 20 exits the interference region C) as a phase 2, a phase in which the conveying device 20 is located in a section from the position C1 to the position P2 as a phase 3, a phase in which the conveying device 20 is located in a section from the position P2 to the position C2 as a phase 4, a phase in which the conveying device 20 is located in a section from the position C2 to the position A1 (a section from when the conveying device 20 enters the interference region C to when the conveying device 20 exits the interference region A) as a phase 5, and a phase in which the conveying device 20 is located in a section from the position A1 to the position P1 as a phase 6. That is, six operation sections obtained by dividing the operation of the conveying device 20 into six portions are set as the phases of the conveying device 20. A parameter VB for defining the conveying speed of the conveying device 20 in the phase 2, and a parameter VC for defining the conveying speed of the conveying device 20 in the phase 5 are set in the conveyance controller 50.

The conveyance controller 50 controls the conveying device 20 to move at a speed designated (defined) by the parameter VB when the operation section of the conveying device 20 is the phase 2, and controls the conveying device 20 to move at a speed designated by the parameter VC when the operation section of the conveying device 20 is the phase 5.

When the operation section of the conveying device 20 is the phase 6 or the phase 1, the conveyance controller 50 controls the conveying device 20 to pass the position B2 at a speed designated by the parameter VB at or after the time at which the slide of the upstream press machine exits the interference region B (the time at which the slide of the upstream press machine passes the position B1). In this way, interference between the slide of the upstream press machine moving upward and the intruding conveying device 20 (the interference in the second form) can be prevented.

When the operation section of the conveying device 20 is the phase 3 or the phase 4, the conveyance controller 50 controls the conveying device 20 to pass the position C2 at a speed designated by the parameter VC at or after the time at which the downstream conveying device exits the interference region C (the time at which the downstream conveying device passes the position C1). In this way, interference between the retreating downstream conveying device and the intruding conveying device 20 (the interference in the third form) can be prevented.

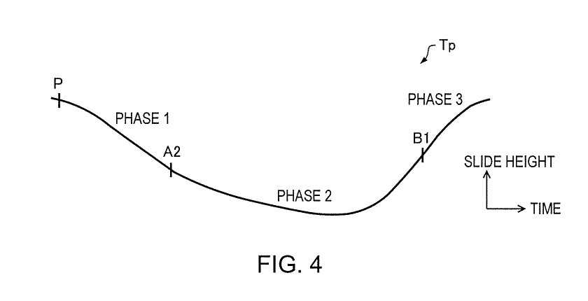

FIG. 4 illustrates the operation locus Tp of the press machine 10. In the operation locus Tp, a position P is set near the top dead center. The press controller 40 manages the phases of the press machine 10 by setting a phase in which the slide 11 is located in a section from the position P to the position A2 as a phase 1, a phase in which the slide 11 is located in a section from the position A2 to the position B1 (a section from when the slide 11 enters the interference region A to when the slide 11 exits the interference region B) as a phase 2, and a phase in which the slide 11 is located in a section from the position B1 to the position P as a phase 3. That is, three operation sections obtained by dividing the operation of the slide 11 into three portions are set as the operation sections of the press machine 10. A parameter VA for defining the speed of the slide 11 in the phase 2 is set in the press controller 40.

The press controller 40 controls the slide 11 to move at a speed designated by the parameter VA when the operation section of the slide 11 of the press machine 10 is the phase 2. When the operation section of the slide 11 of the press machine 10 is the phase 3 or the phase 1, the press controller 40 controls the slide 11 to pass the position A2 at a speed designated by the parameter VA at or after the time at which the upstream conveying device exits the interference region A (the time at which the upstream conveying device passes the position A1). In this way, interference between the retreating upstream conveying device and the slide 11 moving downward (the interference in the first form) can be prevented.

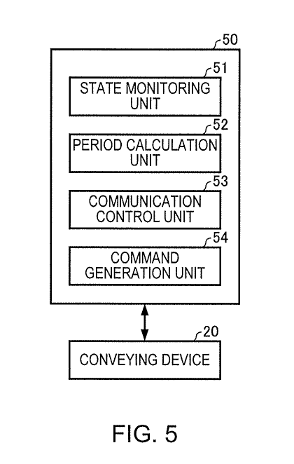

FIG. 5 is a functional block diagram for illustrating the configuration of the conveyance controller 50. The conveyance controller 50 includes a state monitoring unit 51, a period calculation unit 52, a communication control unit 53, and a command generation unit 54.

The state monitoring unit 51 detects which section the conveying device 20 is located in among the sections (phases) illustrated in FIG. 3, and updates a phase variable (section information indicating the operation section in which the conveying device 20 is located). The updated phase variable is output to the communication control unit 53 and the command generation unit 54. The phase of the conveying device 20 in ganged operation is from 1 to 6 when the phase variable is from 1 to 6, and the conveying device 20 is not in a ganged operation state when the phase variable is 0.

The period calculation unit 52 calculates a period TA necessary for the conveying device 20 to exit the interference region A (the time from the current time point to when the conveying device 20 passes the position A1), and calculates a period TC necessary for the conveying device 20 to exit the interference region C (the time from the current time point to when the conveying device 20 passes the position C1). The calculated period TA and the calculated period TC are continuously output while reducing with the lapse of time. The lower limit values of the period TA and the period TC are set to be 0.1 seconds, for example, and 0 seconds are output when the value cannot be calculated.

The communication control unit 53 performs control for transmitting the phase variable output from the state monitoring unit 51 to the press controller 40 on the upstream side and the press controller 40 on the downstream side. The communication control unit 53 transmits the period TA output from the period calculation unit 52 to the press controller 40 on the downstream side, and transmits the period TC output from the period calculation unit 52 to the conveyance controller 50 on the upstream side. For example, the communication control unit 53 of the conveyance controller 50B transmits the period TA to the press controller 40B, and transmits the period TC to the conveyance controller 50A.

The communication control unit 53 receives a period TB necessary for the upstream press machine (slide) to exit the interference region B from the press controller 40 on the upstream side, and receives the period TC necessary for the downstream conveying device to exit the interference region C from the conveyance controller 50 on the downstream side. For example, the communication control unit 53 of the conveyance controller 50B receives the period TB from the press controller 40A, and receives the period TC from the conveyance controller 50C. The communication control unit 53 receives interference region state variables to be described later from the press controllers 40 on the upstream side and the downstream side.

The state monitoring unit 51 monitors the abnormality of the conveying device 20, and sets an abnormality state variable to 1 (own device abnormality) when a failure in a drive unit of the conveying device 20 is detected. The state monitoring unit 51 monitors the period TB received from the press controller 40 on the upstream side and the period TC received from the conveyance controller 50 on the downstream side, sets the abnormality state variable to 2 (upstream device abnormality) when there is abnormality in the received period TB, and sets the abnormality state variable to 3 (downstream device abnormality) when there is abnormality in the received period TC. Specifically, the state monitoring unit 51 determines that there is abnormality in the period TB and the period TC when the received period TB and the received period TC have changed from values other than 0 seconds or 0.1 seconds (lower limit value) to a larger value, when the period TB and the period TC have reduced by a certain percentage or more in comparison to the elapsed time, when the received period TB and the received period TC have exceeded a preset upper limit value, or when values other than 0 seconds or 0.1 seconds have continued for a certain period of time or more. The state monitoring unit 51 determines that there is no abnormality when the abnormality state variable is 0.

The command generation unit 54 controls the operation of the conveying device 20 (conveyance body 22) by calculating an operation command value for a servomotor that drives the conveyance body 22 of the conveying device 20 and outputting the operation command value to the conveying device 20. On the basis of the phase variable output from the state monitoring unit 51 and the period TB, the period TC, and the interference region state variable received by the communication control unit 53, the command generation unit 54 controls the conveying device 20 to pass the position B2 at a speed designated by the parameter VB at or after the time at which the upstream press machine (slide) exits the interference region B (the timing at which the upstream press machine exits the interference region B or the timing after the upstream press machine exits the interference region B) and move in the section of the phase 2 at a speed designated by the parameter VB, and controls the conveying device 20 to pass the position C2 at a speed designated by the parameter VC at or after the time at which the downstream conveying device exits the interference region C (the timing at which the downstream conveying device exits the interference region C or the timing after the downstream conveying device exits the interference region C) and move in the section of the phase 5 at a speed designated by the parameter VC. The command generation unit 54 outputs a stop command when the abnormality state variable output from the state monitoring unit 51 is a value other than 0.

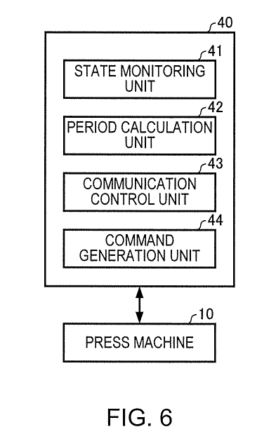

FIG. 6 is a functional block diagram for illustrating the configuration of the press controller 40. The press controller 40 includes a state monitoring unit 41, a period calculation unit 42, a communication control unit 43, and a command generation unit 44.

The state monitoring unit 41 detects which section the slide 11 is located in among the sections (phases) illustrated in FIG. 4, and updates a phase variable (section information indicating the operation section in which the slide 11 is located). The updated phase variable is output to the command generation unit 44. The phase of the press machine 10 in ganged operation is from 1 to 3 when the phase variable is from 1 to 3, and the press machine 10 is not in a ganged operation state when the phase variable is 0.

The period calculation unit 42 calculates a period TB necessary for the slide 11 to exit the interference region B (the time from the current time point to when the slide 11 passes the position B1). The calculated period TB is continuously output while reducing with the lapse of time. The lower limit value of the period TB is set to be 0.1 seconds, for example, and 0 seconds are output when the value cannot be calculated.

The communication control unit 43 performs control for transmitting the period TB output from the period calculation unit 42 to the conveyance controller 50 on the downstream side. For example, the communication control unit 43 of the press controller 40A transmits the period TB to the conveyance controller 50B.

The communication control unit 43 receives a period TA necessary for the upstream conveying device to exit the interference region A from the conveyance controller 50 on the upstream side. For example, the communication control unit 43 of the press controller 40A receives the period TA from the conveyance controller 50A. The communication control unit 43 receives the phase variable (upstream device phase variable) transmitted from the conveyance controller 50 on the upstream side and the phase variable (downstream device phase variable) transmitted from the conveyance controller 50 on the downstream side.

The state monitoring unit 41 monitors the phase variable of the press machine 10 (own device) and the upstream device phase variable and the downstream device phase variable received by the communication control unit 43, and updates the interference region state variable (the state information indicating the state of the interference region). Specifically, the state monitoring unit 41 sets the interference region state variable to 2 (the upstream conveying device is intruding) when the upstream device phase variable changes from 4 to 5, sets the interference region state variable to 3 (there is an unprocessed workpiece) when the upstream device phase variable changes from 5 to 6, sets the interference region state variable to 4 (during press molding) when the phase variable of own device changes from 1 to 2, sets the interference region state variable to 5 (there is a processed workpiece) when the phase variable of own device changes from 2 to 3, sets the interference region state variable to 6 (the downstream conveying device is intruding) when the downstream device phase variable changes from 1 to 2, and sets the interference region state variable to 1 (there is no workpiece) when the downstream device phase variable changes from 2 to 3. The state monitoring unit 41 sets the interference region state variable to 0 when the press machine is not in a ganged operation state. When the ganged operation starts, the state monitoring unit 41 checks the state of the workpiece by a sensor, visual check, or the like, and sets the interference region state variable to any one of the values 1, 3, and 5. The communication control unit 43 transmits the interference region state variable output from the state monitoring unit 41 to the conveyance controller 50 on the upstream side and the conveyance controller 50 on the downstream side.

The state monitoring unit 41 monitors the abnormality of the press machine 10, and sets an abnormality state variable to 1 (own device abnormality) when a failure in a drive unit of the press machine 10 is detected. The state monitoring unit 41 monitors the period TA received from the conveyance controller 50 on the upstream side, and sets the abnormality state variable to 2 (upstream device abnormality) when there is abnormality in the received period TA. The determination of whether there is abnormality in the received period TA is the same as the determination for the period TB and the period TC in the conveyance controller 50. There is no abnormality when the abnormality state variable is 0.

The command generation unit 44 controls the operation of the press machine 10 (slide 11) by calculating an operation command value for a servomotor that drives the slide 11 of the press machine 10 and outputting the operation command value to the press machine 10. On the basis of the interference region state variable output from the state monitoring unit 41 and the period TA received by the communication control unit 43, the command generation unit 44 controls the press machine 10 to pass the position A2 at a speed determined by the parameter VA at or after the time at which the upstream conveying device exits the interference region A (the timing at which the upstream conveying device exits the interference region A or the timing after the upstream conveying device exits the interference region A) and move in the section of the phase 2 at a speed determined by the parameter VA. The command generation unit 44 outputs a stop command when the abnormality state variable output from the state monitoring unit 41 is a value other than 0.

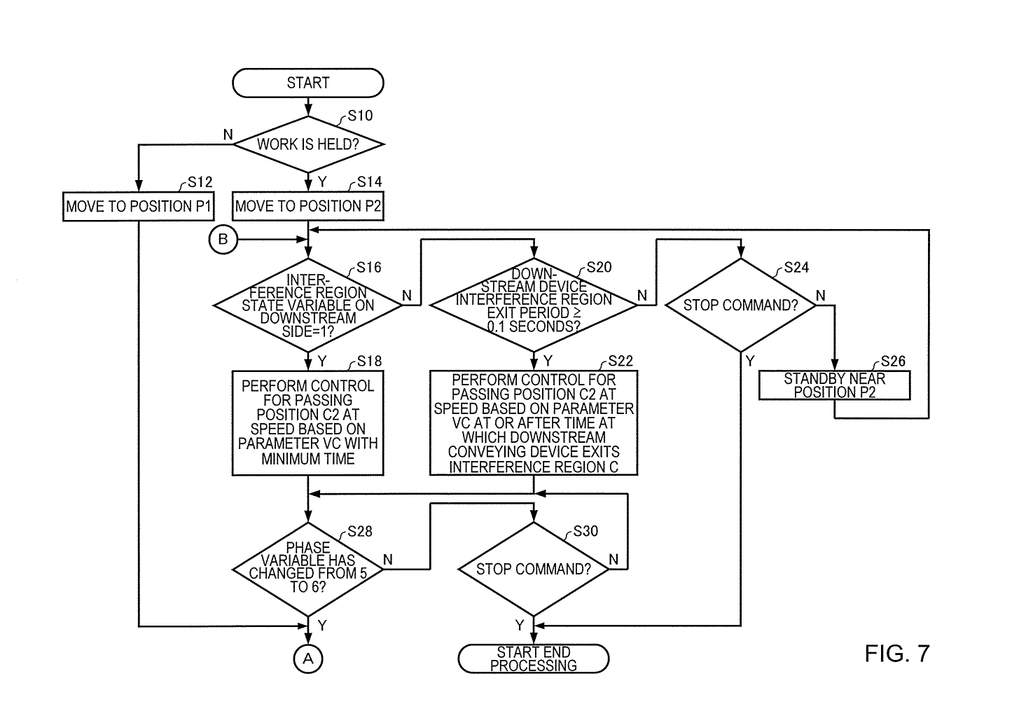

Next, an example of the processing of the conveyance controller 50 is described with reference to flowcharts of FIG. 7 to FIG. 10.

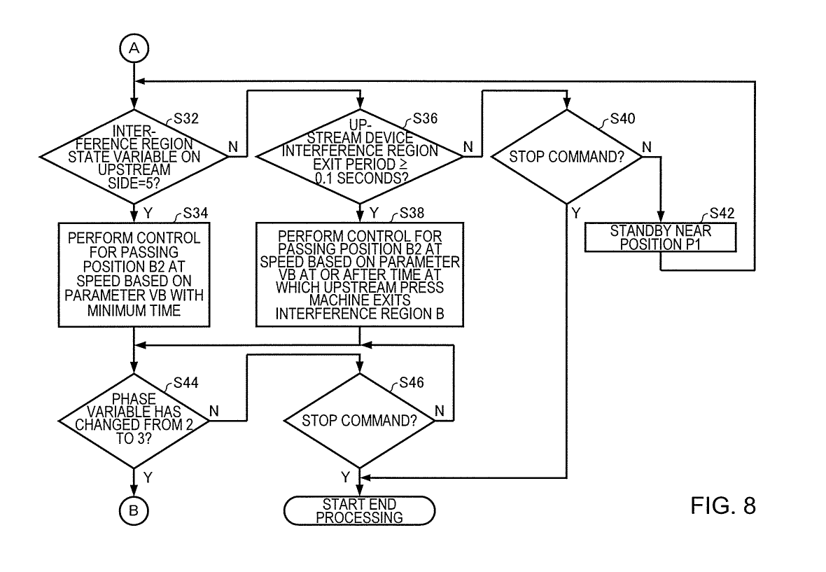

FIG. 7 and FIG. 8 are flowcharts illustrating the flow of the ganged operation processing of the conveying device 20. First, the conveyance controller 50 determines whether the conveying device 20 is holding the workpiece (Step S10). For example, whether the conveying device 20 is holding the workpiece is determined on the basis of a state acquired by the sensor or a value input by an operator that has performed visual check. When the conveying device 20 is not holding the workpiece (N in Step S10), the command generation unit 54 controls the conveying device 20 to move to a place near the position P1 (Step S12), and the processing proceeds to Step S32. The expression “near the position P1” herein means a position in which the conveying device 20 can operate without interfering with the upstream press machine and the downstream press machine and can keep a sufficient distance to accelerate to a speed designated by the parameter VB before moving to the position B2 even if the conveying device 20 is in the position.

When the conveying device 20 is holding the workpiece (Y in Step S10), the command generation unit 54 controls the conveying device 20 to move to a place near the position P2 (Step S14), and the processing proceeds to Step S16. The expression “near the position P2” herein means a position in which the conveying device 20 can operate without interfering with the upstream press machine and the downstream press machine and can keep a sufficient distance to accelerate to a speed designated by the parameter VC before moving to the position C2 even if the conveying device 20 is in the position.

Next, the conveyance controller 50 determines whether the interference region state variable received from the press controller 40 on the downstream side is 1 (the state information indicates that there is no workpiece, that is, there is no workpiece in the downstream press machine, and the downstream conveying device is not in the interference region C) (Step S16). When the interference region state variable is 1 (Y in Step S16), the command generation unit 54 controls the conveying device 20 to pass the position C2 at a speed designated by the parameter VC with the minimum time (Step S18), and the processing proceeds to Step S28.

When the interference region state variable is not 1 (N in Step S16), the conveyance controller 50 determines whether a downstream device interference region exit period (the period TC necessary for the downstream conveying device to exit the interference region C) received from the conveyance controller 50 on the downstream side is equal to or more than 0.1 seconds (Step S20). When the downstream device interference region exit period is equal to or more than 0.1 seconds (Y in Step S20), the command generation unit 54 controls the conveying device 20 to pass the position C2 at a speed designated by the parameter VC at or after the time at which the downstream conveying device exits the interference region C (Step S22), and the processing proceeds to Step S28.

When the downstream device interference region exit period is not equal to or more than 0.1 seconds (N in Step S20), the conveyance controller 50 determines whether the stop command has been output (Step S24), and starts the end processing when the stop command has been output (Y in Step S24). When the stop command has not been output (N in Step S24), the command generation unit 54 controls the conveying device 20 to move to a place near the position P2 and be on standby (be on standby as it is when the conveying device 20 is stopped near the position P2) (Step S26), and the processing proceeds to Step S16.

Next, the conveyance controller 50 determines whether the phase variable output from the state monitoring unit 51 (the phase variable of own device) has changed from 5 to 6 (Step S28). When the phase variable has not changed from 5 to 6 (N in Step S28), the conveyance controller 50 determines whether the stop command has been output (Step S30). When the stop command has been output (Y in Step S30), the conveyance controller 50 starts the end processing. When the stop command has not been output (N in Step S30), the processing proceeds to Step S28.

When the phase variable has changed from 5 to 6 (Y in Step S28), the conveyance controller 50 determines whether the interference region state variable received from the press controller 40 on the upstream side is 5 (the state information indicates that there is a processed workpiece, that is, there is a processed workpiece in the upstream press machine, and the slide 11 is not in the interference region B) (Step S32). When the interference region state variable is 5 (Y in Step S32), the command generation unit 54 controls the conveying device 20 to pass the position B2 at a speed designated by the parameter VB with the minimum time (Step S34), and the processing proceeds to Step S44.

When the interference region state variable is not 5 (N in Step S32), the conveyance controller 50 determines whether an upstream device interference region exit period (the period TB necessary for the upstream press machine to exit the interference region B) received from the press controller 40 on the upstream side is equal to or more than 0.1 seconds (Step S36). When the upstream device interference region exit period is equal to or more than 0.1 seconds (Y in Step S36), the command generation unit 54 controls the conveying device 20 to pass the position B2 at a speed designated by the parameter VB at or after the time at which the upstream press machine exits the interference region B (Step S38), and the processing proceeds to Step S44.

When the upstream device interference region exit period is not equal to or more than 0.1 seconds (N in Step S36), the conveyance controller 50 determines whether the stop command has been output (Step S40). When the stop command has been output (Y in Step S40), the conveyance controller 50 starts the end processing. When the stop command has not been output (N in Step S40), the command generation unit 54 controls the conveying device 20 to move to a place near the position P1 and be on standby (be on standby as it is when the conveying device 20 is stopped near the position P1) (Step S42), and the processing proceeds to Step S32.

Next, the conveyance controller 50 determines whether the phase variable of own device has changed from 2 to 3 (Step S44). When the phase variable of own device has changed from 2 to 3 (Y in Step S44), the processing proceeds to Step S16. When the phase variable has not changed from 2 to 3 (N in Step S44), the conveyance controller 50 determines whether the stop command has been output (Step S46). When the stop command has been output (Y in Step S46), the conveyance controller 50 starts the end processing. When the stop command has not been output (N in Step S46), the processing proceeds to Step S44.

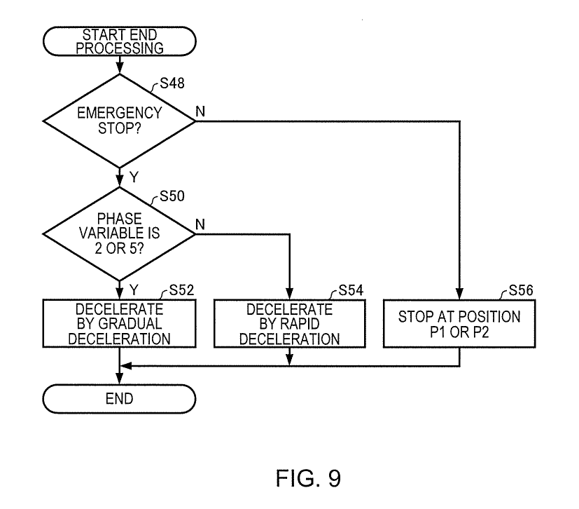

FIG. 9 is a flowchart illustrating the flow of ganged operation ending processing of the conveying device 20. First, the conveyance controller 50 determines whether the type of the stop command is an emergency stop (Step S48). When the type of the stop command is an emergency stop (Y in Step S48), the conveyance controller 50 determines whether or not the phase variable of own device is 2 or 5 (that is, own device is in the interference region) (Step S50).

When the phase variable is 2 or 5 (Y in Step S50), the command generation unit 54 controls the conveying device 20 to decelerate by gradual deceleration (Step S52). When the phase variable is not 2 or 5 (is any one of 3, 4, 6, and 1) (N in Step S50), the command generation unit 54 controls the conveying device 20 to decelerate by rapid deceleration (Step S54). In this way, at the time of an emergency stop, interference between devices can be prevented even when communication among the controllers is not possible by decelerating the conveying device 20 by gradual deceleration so that the conveying device 20 exits the interference region when the conveying device 20 is in the interference region, and by decelerating the conveying device 20 by rapid deceleration so that the conveying device 20 does not approach the interference region when the conveying device 20 is not in the interference region. When the type of the stop command is not an emergency stop (N in Step S48), the command generation unit 54 controls the conveying device 20 to move to a place near the position P1 or P2 and stop at that place (Step S56).

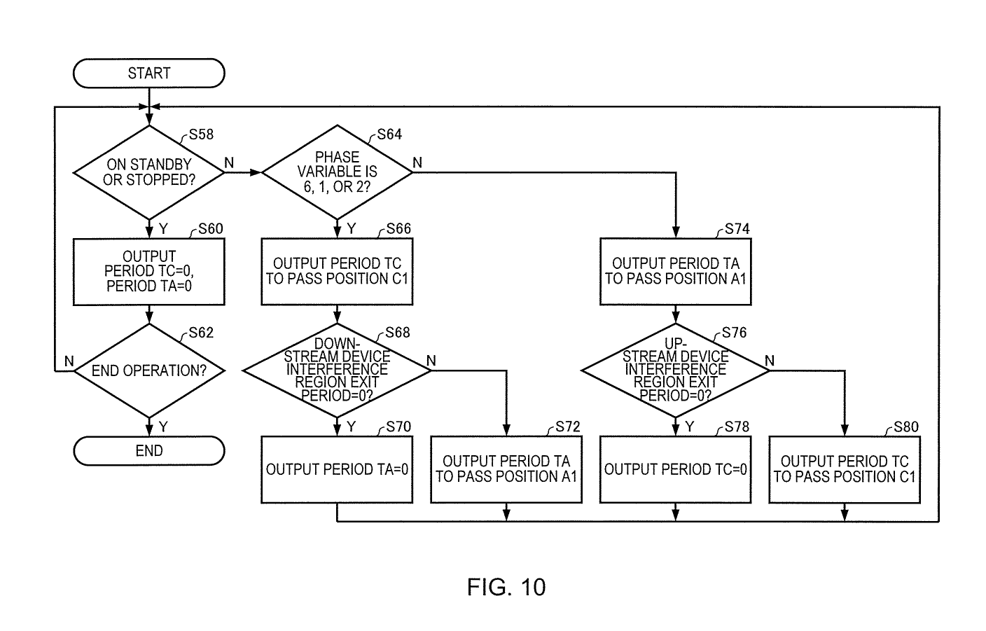

FIG. 10 is a flowchart illustrating the flow of the processing for outputting an interference region exit period of the conveying device 20. First, the conveyance controller 50 determines whether processing for causing the conveying device 20 to standby or stop is in execution (Step S58). When the processing is in execution (Y in Step S58), the period calculation unit 52 outputs 0 for both the period TC necessary for the conveying device 20 to pass the position C1 (time information indicating the timing at which the conveying device 20 exits the interference region C) and the period TA necessary for the conveying device 20 to pass the position A1 (the time information indicating the timing at which the conveying device 20 exits the interference region A) (Step S60). The period TC is transmitted to the conveyance controller 50 on the upstream side, and the period TA is transmitted to the press controller 40 on the downstream side. Next, the conveyance controller 50 determines whether to end the operation (Step S62). When the operation is to be continued (N in Step S62), the processing proceeds to Step S58.

When the processing for causing the conveying device 20 to standby or stop is not in execution (N in Step S58), the conveyance controller 50 determines whether or not the phase variable of own device is 6, 1, or 2 (Step S64). When the phase variable is 6, 1, or 2 (Y in Step S64), the period calculation unit 52 calculates and outputs the period TC necessary for the conveying device 20 to pass the position C1 (Step S66). The conveying device 20 is controlled to pass the position B2 at or after the time at which the upstream press machine exits the interference region B and move in the phase 2 (the section from the position B2 to the position C1) at a speed designated by the parameter VB, and hence the period TC can be calculated from the upstream device interference region exit period received from the press controller 40 on the upstream side, the parameter VB, and the current position of the conveying device 20.

Next, the conveyance controller 50 determines whether the downstream device interference region exit period received from the conveyance controller 50 on the downstream side is 0 (Step S68). When the downstream device interference region exit period is 0 (Y in Step S68), the period calculation unit 52 outputs 0 as the period TA (Step S70). When the downstream device interference region exit period is not 0 (N in Step S68), the period calculation unit 52 calculates and outputs the period TA necessary for the conveying device 20 to pass the position A1 (Step S72). The conveying device 20 is controlled to pass the position C2 at or after the time at which the downstream conveying device exits the interference region C and move in the phase 5 (the section from the position C2 to the position A1) at a speed designated by the parameter VC, and hence the period TA can be calculated from the downstream device interference region exit period received from the conveyance controller 50 on the downstream side, the parameter VC, and the current position of the conveying device 20.

When the phase variable is not 6, 1, or 2 (N in Step S64), the period calculation unit 52 calculates and outputs the period TA necessary for the conveying device 20 to pass the position A1 (Step S74). Next, the conveyance controller 50 determines whether the upstream device interference region exit period received from the press controller 40 on the upstream side is 0 (Step S76). When the upstream device interference region exit period is 0 (Y in Step S76), the period calculation unit 52 outputs 0 as the period TC (Step S78). When the upstream device interference region exit period is not 0 (N in Step S76), the period calculation unit 52 calculates and outputs the period TC necessary for the conveying device 20 to pass the position C1 (Step S80).

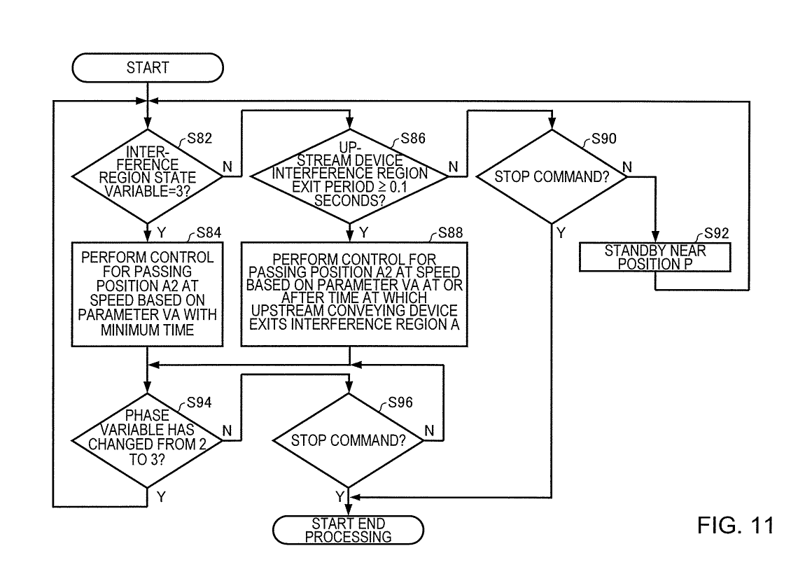

Next, an example of the processing the press controller 40 is described with reference to flowcharts of FIG. 11 to FIG. 13.

FIG. 11 is a flowchart illustrating the flow of ganged operation processing of the press machine 10. The press machine 10 starts the ganged operation from a place near the top dead center. The expression “near the top dead center” herein means a location at a slide height, which is higher than the position B1 and in which both the upstream conveying device and the downstream conveying device can intrude, and at which the press machine 10 can keep a sufficient distance to accelerate to a speed designated by the parameter VA before moving to the position A2.

First, the press controller 40 determines whether the interference region state variable output from the state monitoring unit 41 is 3 (the state information indicates that there is a workpiece to be processed, that is, an unprocessed workpiece, and the upstream conveying device is not in the interference region A) (Step S82). When the interference region state variable is 3 (Y in Step S82), the command generation unit 44 controls the press machine 10 to pass the position A2 at a speed designated by the parameter VA with the minimum time (Step S84), and the processing proceeds to Step S94.

When the interference region state variable is not 3 (N in Step S82), the press controller 40 determines whether the upstream device interference region exit period received from the conveyance controller 50 on the upstream side (the period TA necessary for the upstream conveying device to exit the interference region A) is equal to or more than 0.1 seconds (Step S86). When the upstream device interference region exit period is equal to or more than 0.1 seconds (Y in Step S86), the command generation unit 44 controls the press machine 10 to pass the position A2 at a speed designated by the parameter VA at or after the time at which the upstream conveying device exits the interference region A (Step S88), and the processing proceeds to Step S94.

When the upstream device interference region exit period is not equal to or more than 0.1 seconds (N in Step S86), the press controller 40 determines whether the stop command has been output (Step S90). When the stop command has been output (Y in Step S90), the press controller 40 starts the end processing. When the stop command has not been output (N in Step S90), the command generation unit 44 controls the press machine 10 to move to a place near the position P (near the top dead center) and be on standby (be on standby as it is when the press machine 10 is stopped near the position P) (Step S92), and the processing proceeds to Step S82.

Next, the press controller 40 determines whether the phase variable of own device has changed from 2 to 3 (Step S94). When the phase variable of own device has changed from 2 to 3 (Y in Step S94), the processing proceeds to Step S82. When the phase variable has not changed from 2 to 3 (N in Step S94), the press controller 40 determines whether the stop command has been output (Step S96). When the stop command has been output (Y in Step S96), the press controller 40 starts the end processing. When the stop command has not been output (N in Step S96), the processing proceeds to Step S94.

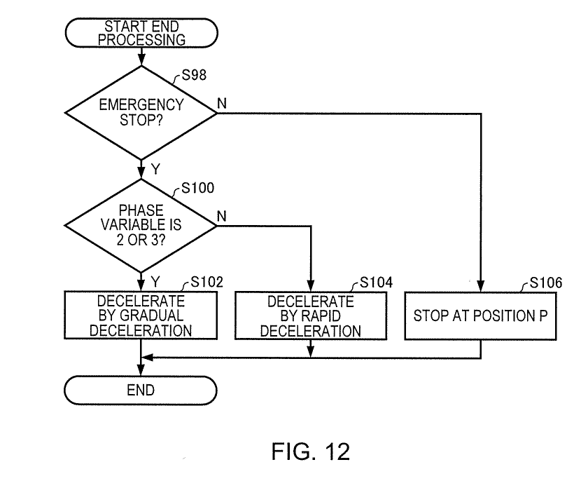

FIG. 12 is a flowchart illustrating the flow of ganged operation ending processing of the press machine 10. First, the press controller 40 determines whether the type of the stop command is an emergency stop (Step S98). When the type of the stop command is an emergency stop (Y in Step S98), the press controller 40 determines whether or not the phase variable of own device is 2 or 3 (Step S100).

When the phase variable is 2 or 3 (Y in Step S100), the command generation unit 44 controls the slide 11 to decelerate by gradual deceleration (Step S102). When the phase variable is not 2 or 3 (the phase variable is 1) (N in Step S100), the command generation unit 44 controls the slide 11 to decelerate by rapid deceleration (Step S104). In this way, at the time of an emergency stop, interference between devices can be prevented even when communication among the controllers is not possible by decelerating the slide 11 by gradual deceleration so that the slide 11 exits the interference region when the slide 11 is in the interference region, and by decelerating the slide 11 by rapid deceleration so that the slide 11 does not approach the interference region when the slide 11 has not entered the interference region. When the type of the stop command is not an emergency stop (N in Step S98), the command generation unit 44 controls the slide 11 to move to a place near the position P and stop at that place (Step S106).

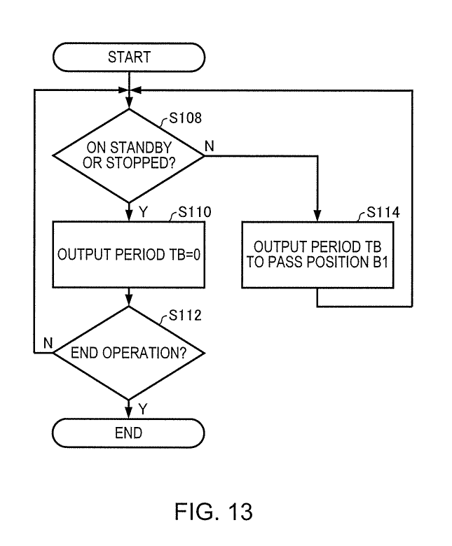

FIG. 13 is a flowchart illustrating the flow of processing for outputting the interference region exit period of the press machine 10. First, the press controller 40 determines whether processing for causing the press machine 10 to standby or stop is in execution (Step S108). When the processing is in execution (Y in Step S108), the period calculation unit 42 outputs 0 as the period TB necessary for the slide 11 to pass the position B1 (the time information indicating the timing at which the slide 11 exits the interference region B) (Step S110). The period TB is transmitted to the conveyance controller 50 on the downstream side. Next, the press controller 40 determines whether to end the operation (Step S112). When the operation is to be continued (N in Step S112), the processing proceeds to Step S108.

When the processing for causing the press machine 10 to standby or stop is not in execution (N in Step S108), the period calculation unit 42 calculates and outputs the period TB necessary for the slide 11 to pass the position B1 (Step S114). The slide 11 is controlled to pass the position A2 at or after the time at which the upstream conveying device exits the interference region A and move in the phase 2 (the section from the position A2 to the position B1) at a speed designated by the parameter VA, and hence the period TB can be calculated from the upstream device interference region exit period received from the conveyance controller 50 on the upstream side (the period TA necessary for the upstream conveying device to exit the interference region A), the parameter VA, and the current position of the slide 11.

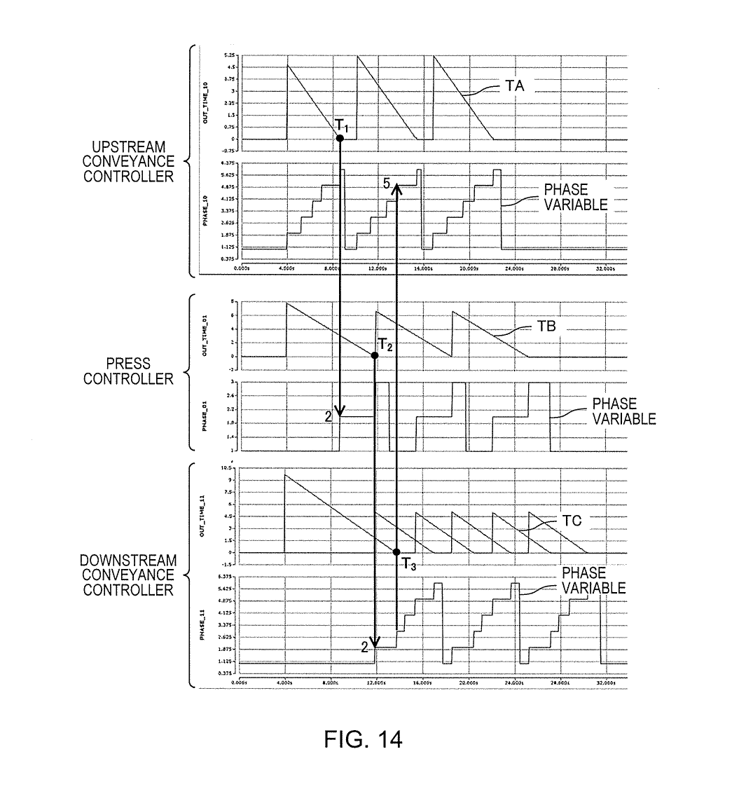

FIG. 14 illustrates an example of the transition of variables (the period TA, the period TB, the period TC, and the phase variables) generated by the upstream conveyance controller, the press controller, and the downstream conveyance controller, respectively. In the example illustrated in FIG. 14, the devices are in ganged operation such that the press machine enters the interference region A (the phase variable of the press machine changes to 2) at time T₁ at which the upstream conveying device exits the interference region A (the timing at which the phase variable of the upstream conveying device changes to 6), the downstream conveying device enters the interference region B (the phase variable of the downstream conveying device changes to 2) at time T₂ at which the press machine exits the interference region B (the timing at which the phase variable of the press machine changes to 3), and the upstream conveying device enters the interference region C (the phase variable of the upstream conveying device changes to 5) at time T₃ at which the downstream conveying device exits the interference region C (the timing at which the phase variable of the downstream conveying device changes to 3).

In the operation control device according to one embodiment of the invention, the devices (the upstream conveying device and the press machine, the press machine and the downstream conveying device, and the downstream conveying device and the upstream conveying device) can be operated in ganged operation so as not to interfere with each other by acquiring the time information indicating the timing at which the upstream conveying device exits the interference region A from the conveyance controller 50 on the upstream side and controlling the slide 11 to enter the interference region A at or after the time (time of day) at which the upstream conveying device exits the interference region A by the press controller 40, by acquiring the time information indicating the timing at which the slide 11 exits the interference region B from the press controller 40 and controlling the downstream conveying device to enter the interference region B at or after the time (time of day) at which the slide 11 exits the interference region B by the conveyance controller 50 on the downstream side, and by acquiring the time information indicating the timing at which the downstream conveying device exits the interference region C from the conveyance controller 50 on the downstream side and controlling the upstream conveying device to enter the interference region C at or after the time (time of day) at which the downstream conveying device exits the interference region C by the conveyance controller 50 on the upstream side.

In the operation control device according to one embodiment of the invention, the controllers generate operation command values without relying on master signals from other devices or the outside, and hence the operation command values for the devices can be prevented from being affected by the communication jitter or the difference of the CPU clocks. The ganged operation can be performed even when the communication speed among the controllers is slow or when there is variation in the communication speed. In that case, the speed can be corrected by measuring the communication delay among the controllers in advance and subtracting the value from an interference range exit period acquired from other controllers.

Only some embodiments of the invention have been described in detail above, but a person skilled in the art would readily appreciate that various modifications can be made without materially departing from the novel teachings and advantages of the invention.

### REFERENCE SIGNS LIST

1 Press line
10 Press machine
11 Slide
12 Upper die
13 Lower die
14 Bolster
20 Conveying device
21 Main body
22 Conveyance body
23 Holding device
30 Material carry-in device
31 Carry-in controller
32 Material carry-out device
33 Carry-out controller
40 Press controller
41 State monitoring unit
42 Period calculation unit
43 Communication control unit
44 Command generation unit
50 Conveyance controller
51 State monitoring unit
52 Period calculation unit
53 Communication control unit
54 Command generation unit
W Workpiece

1. An operation control device for a press line including a first press machine, a first conveying device that carries a workpiece to be processed into the first press machine, and a second conveying device that carries a processed workpiece out of the first press machine, the operation control device comprising:
a first press controller that controls the first press machine;
a first conveyance controller that controls the first conveying device; and
a second conveyance controller that controls the second conveying device, wherein:
the first press controller, the first conveyance controller, and the second conveyance controller are communicably connected to each other;
the first conveyance controller transmits, to the first press controller, time information indicating a timing at which the first conveying device exits an interference region in which the first conveying device interferes with the first press machine;
the first press controller controls the first press machine so that, at or after a time at which the first conveying device exits the interference region, a slide of the first press machine enters the interference region in which the first press machine interferes with the first conveying device on the basis of the time information received from the first conveyance controller, and transmit, to the second conveyance controller, time information indicating a timing at which the slide of the first press machine exits an interference region in which the first press machine interferes with the second conveying device; and
the second conveyance controller controls the second conveying device so that, at or after a time at which the slide of the first press machine exits the interference region, the second conveying device enters an interference region in which the second conveying device interferes with the first press machine on the basis of the time information received from the first press controller.

2. The operation control device for a press line according to claim 1, wherein:
the second conveyance controller transmits, to the first conveyance controller, time information indicating a timing at which the second conveying device exits an interference region in which the second conveying device interferes with the first conveying device; and
the first conveyance controller controls the first conveying device so that, at or after a time at which the second conveying device exits the interference region, the first conveying device enters an interference region in which the first conveying device interferes with the second conveying device on the basis of the time information received from the second conveyance controller.

3. The operation control device for a press line according to claim 2, wherein:
the first press controller controls the first press machine so that the slide of the first press machine enters the interference region in which the first press machine interferes with the first conveying device, at a speed designated in advance;
the second conveyance controller controls the second conveying device so that the second conveying device enters the interference region in which the second conveying device interferes with the first press machine, at a speed designated in advance; and
the first conveyance controller controls the first conveying device so that the first conveying device enters the interference region in which the first conveying device interferes with the second conveying device, at a speed designated in advance.

4. The operation control device for a press line according to claim 1, wherein:
the press line further includes a second press machine, and a second press controller that controls the second press machine;
the second conveying device carries a workpiece carried out from the first press machine into the second press machine; and
the second conveyance controller and the second press controller are communicably connected to each other.

5. The operation control device for a press line according to claim 4, wherein:
the second conveyance controller transmits, to the second press controller, time information indicating a timing at which the second conveying device exits an interference region in which the second conveying device interferes with the second press machine; and
the second press controller controls the second press machine so that, at or after a time at which the second conveying device exits the interference region, a slide of the second press machine enters an interference region in which the second press machine interferes with the second conveying device on the basis of the time information received from the second conveyance controller.

6. The operation control device for a press line according to claim 5, wherein the second press controller controls the second press machine so that the slide of the second press machine enters the interference region in which the second press machine interferes with the second conveying device, at a speed designated in advance.

7. The operation control device for a press line according to claim 2, wherein:
the first conveyance controller updates section information indicating an operation section in which the first conveying device is located among a plurality of operation sections obtained by dividing an operation of the first conveying device, and transmit the updated section information to the first press controller;
the second conveyance controller updates section information indicating an operation section in which the second conveying device is located among a plurality of operation sections obtained by dividing an operation of the second conveying device, and transmit the updated section information to the first press controller;
the first press controller updates section information indicating an operation section in which the slide of the first press machine is located among a plurality of operation sections obtained by dividing an operation of the slide of the first press machine, update state information indicating a state of the interference region on the basis of the updated section information and the section information received from the first conveyance controller and the second conveyance controller, and transmit the updated state information to the first conveyance controller and the second conveyance controller;
the first press controller controls the first press machine so that the slide of the first press machine enters the interference region in which the first press machine interferes with the first conveying device, with minimum time when the state information indicates that there is a workpiece to be processed, and control the first press machine so that, at or after a time at which the first conveying device exits the interference region, the slide of the first press machine enters the interference region in which the first press machine interferes with the first conveying device on the basis of the time information received from the first conveyance controller in a case other than a case in which the state information indicates that there is a workpiece to be processed;
the second conveyance controller controls the second conveying device so that the second conveying device enters the interference region in which the second conveying device interferes with the first press machine, with minimum time when the state information received from the first press controller indicates that there is a processed workpiece, and control the second conveying device so that, at or after a time at which the slide of the first press machine exits the interference region, the second conveying device enters the interference region in which the second conveying device interferes with the first press machine on the basis of the time information received from the first press controller in a case other than a case in which the state information indicates that there is a processed workpiece; and
the first conveyance controller controls the first conveying device so that the first conveying device enters the interference region in which the first conveying device interferes with the second conveying device, with minimum time when the state information received from the first press controller indicates that there is no workpiece, and control the first conveying device so that, at or after a time at which the second conveying device exits the interference region, the first conveying device enters the interference region in which the first conveying device interferes with the second conveying device on the basis of the time information received from the second conveyance controller in a case other than a case in which the state information indicates that there is no workpiece.

8. The operation control device for a press line according to claim 2, wherein:
the first press controller monitors an abnormality of the first press machine, and monitor an abnormality of the first conveying device by monitoring the time information received from the first conveyance controller;
the second conveyance controller monitors an abnormality of the second conveying device, and monitor an abnormality of the first press machine by monitoring the time information received from the first press controller; and
the first conveyance controller monitors an abnormality of the first conveying device, and monitor an abnormality of the second conveying device by monitoring the time information received from the second conveyance controller.

9. An operation control method for a press line including a first press machine, a first conveying device that carries a workpiece to be processed into the first press machine, a second conveying device that carries a processed workpiece out of the first press machine, a first press controller that controls the first press machine, a first conveyance controller that controls the first conveying device, and a second conveyance controller that controls the second conveying device, the operation control method comprising the steps of:
causing the first conveyance controller to transmit, to the first press controller, time information indicating a timing at which the first conveying device exits an interference region in which the first conveying device interferes with the first press machine;
causing the first press controller to control the first press machine so that, at or after a time at which the first conveying device exits the interference region, a slide of the first press machine enters the interference region in which the first press machine interferes with the first conveying device on the basis of the time information received from the first conveyance controller, and transmit, to the second conveyance controller, time information indicating a timing at which the slide of the first press machine exits an interference region in which the first press machine interferes with the second conveying device; and
causing the second conveyance controller to control the second conveying device so that, at or after a time at which the slide of the first press machine exits the interference region, the second conveying device enters the interference region in which the second conveying device interferes with the first press machine on the basis of the time information received from the first press controller.

10. The operation control method for a press line according to claim 9, wherein:
the press line further includes a second press machine, and a second press controller that controls the second press machine;
the second conveying device carries a workpiece carried out from the first press machine into the second press machine; and
the operation control method comprises the steps of:
causing the second conveyance controller to transmit, to the second press controller, time information indicating a timing at which the second conveying device exits an interference region in which the second conveying device interferes with the second press machine; and
causing the second press controller to control the second press machine so that, at or after a time at which the second conveying device exits the interference region, a slide of the second press machine enters an interference region in which the second press machine interferes with the second conveying device on the basis of the time information received from the second conveyance controller.
